(19) United States
(12) Patent Application Publication
(10) Pub. No.: US 2018/0201794 A1
(43) Pub. Date: Jul. 19, 2018

(54) SUSTAINABLE ADDITIVES FOR ANTI-CORROSION COATINGS FOR SUBSTRATES

(71) Applicants: THE BOEING COMPANY, CHICAGO, IL (US); Universidade Federal de Minas Gerais - UFMG, Belo Horizonte (BR)

(72) Inventors: Patrick John Kinlen, Fenton, MO (US); Waynie Mark Schuette, Troy, IL (US); Lucia Pinheiro Santos Pimenta, Belo Horizonte (BR); Catherine Jane Parrish, Sao Jose dos Campos (BR)

(73) Assignees: THE BOEING COMPANY; Universidade Federal de Minas Gerais - UFMG

(21) Appl. No.: 15/410,140

(22) Filed: Jan. 19, 2017

(51) Int. Cl. C09D 5/08; C09D 175/04

(52) U.S. Cl. CPC C09D 5/086; C09D 175/04

(57) ABSTRACT

The present disclosure is directed to methods, systems and apparatuses for imparting anti-corrosion properties into coatings for aluminum, aluminum alloy, copper and copper alloys by preparing and applying corrosion inhibition formulations comprising plant extracts comprising anti-corrosion properties.

### TECHNOLOGICAL FIELD

The present disclosure generally relates to the field of corrosion inhibitors for use with aluminum, aluminum alloys copper and copper alloys. More particularly, the present disclosure relates to anti-corrosion compositions and methods for making anti-corrosion compositions that do not contain hexavalent chromium.

### BACKGROUND

Presently, industry continues to respond to strong regulatory needs to eliminate the use of compounds thought to be environmentally toxic and carcinogenic. Representative compounds include hexavalent chromium used in connection with corrosion inhibiting formulations. As a result, there exists a need to identify chromium substitute formulations that possess adequate or superior corrosion inhibition relative to the disfavored chromium formulations.

The list of potential replacement compounds for the chromium-containing compounds that could be viable compounds that exhibit a predetermined degree of corrosion inhibition is large. However, identifying viable corrosion inhibition candidates requires significant testing and a commensurate amount of experimentation and capital to conduct such testing.

An anti-corrosion coating alternative that approximates or exceeds the corrosion resistance of anti-corrosion coatings that contain hexavalent chromium, along with methods for making the same, would be advantageous.

### BRIEF SUMMARY

An aspect of the present disclosure contemplates a method for inhibiting corrosion of a substrate comprising applying a composition to a substrate, with the composition comprising an extract derived from a plant genus comprising: Annona, Inga, Mangifera; Taraxacum; Bidens; Plantango; Chamomilla; Solidago, and combinations thereof, and inhibiting corrosion of a substrate, with the substrate comprising a substrate surface.

In another aspect, in the step of applying a composition to a substrate, the composition comprises an extract derived from a plant species comprising: Annona crassiflora; Inga (sp.); Mangifera indica; Annona squamosa; Taraxacum officinale; Bidens pilosa; Plantango major; Chamomilla recutita; Solidago chilensis; and combinations thereof.

In yet another aspect, in the step of applying a composition to a substrate the composition comprises an extract derived from a plant species comprising: Annona crassiflora; Annona squamosa; Mangifera indica; Bidens pilosa; and combinations thereof.

In a still further aspect, in the step of applying a composition to a substrate the composition comprises an extract derived from a plant species comprising Annona crassiflora; Annona squamosa; Mangifera indica; Bidens pilosa; and combinations thereof, and with the extract present in the composition at a concentration ranging from about 5% to about 20%.

In another aspect, in the step of applying a composition to a substrate, the substrate comprises aluminum, aluminum alloy, copper, copper alloy, and combinations thereof.

In a further aspect, the substrate comprises aluminum alloy 2024 T3 or aluminum alloy 7075.

In a further aspect, the present disclosure contemplates a composition for inhibiting corrosion on a substrate, with the composition comprising an extract derived from a plant genus comprising Annona, Inga, Mangifera; Taraxacum; Bidens; Plantango; Chamomilla; Solidago; and combinations thereof.

In another aspect, the composition comprises an extract derived from a plant selected from a plant species comprising Annona crassiflora; Inga (sp.); Mangifera indica; Annona squamosa; Taraxacum officinale; Bidens pilosa; Plantango major; Chamomilla recutita; Solidago chilensis; and combinations thereof.

In a still further aspect, the composition comprises an extract derived from a plant species comprising Annona crassiflora; Annona squamosa; Mangifera indica L; Bidens pilosa; and combinations thereof.

In another aspect, the composition comprises an extract derived from a plant selected from a plant species comprising Annona crassiflora; Annona squamosa; Bidens pilosa; and combinations thereof, with the extract present in the composition at a concentration ranging from about 5% to about 20%.

In yet another aspect, the composition comprises an extract derived from a plant genus that is extracted from plant seeds, plant pulp, plant peel, plant leaves, and combinations thereof.

In a still further aspect, the composition further comprises a primer.

In yet another aspect, the composition further comprises a primer comprising a polyurethane-containing compound.

In yet another aspect, the composition comprising a plant extract described above is an additive incorporated in a coating formulation.

A further aspect is directed to a coating for inhibiting corrosion, with the coating comprising an extract derived from a plant genus comprising: Annona, Inga, Mangifera; Taraxacum; Bidens; Plantango; Chamomilla; Solidago; and combinations thereof.

In another aspect, the coating comprises an extract derived from a plant selected from a plant species comprising: Annona crassiflora; Inga (sp.); Mangifera indica; Annona squamosa; Taraxacum officinale; Bidens pilosa; Plantango major; Chamomilla recutita; Solidago chilensis; and combinations thereof.

In a still further aspect, the coating comprises a composition comprising an extract derived from a plant selected from the group comprising Annona crassiflora; Annona squamosa; Mangifera indica; Bidens pilosa; and combinations thereof.

In another aspect, the coating comprises a composition comprising an extract derived from a plant species comprising Annona crassiflora; Annona squamosa; Mangifera indica; Bidens pilosa; and combinations thereof, with the extract present in the composition at a concentration ranging from about 5% to about 20%.

A still further aspect of the disclosure is directed to a substrate comprising a coating for inhibiting corrosion on the substrate, with the coating comprising an extract derived from a plant genus comprising: Annona, Inga, Mangifera; Taraxacum; Bidens; Plantango; Chamomilla; Solidago; and combinations thereof.

In a further aspect, the substrate comprises a coating comprising an extract derived from a plant species comprising: Annona crassiflora; Inga (sp.); Mangifera indica; Annona squamosa; Taraxacum officinale; Bidens pilosa; Plantango major; Chamomilla recutita; Solidago chilensis; and combinations thereof.

In another aspect, the substrate comprises a coating comprising a composition having an extract derived from a plant species comprising Annona crassiflora; Annona squamosa; Mangifera indica; Bidens pilosa; and combinations thereof, with the extract present in the composition at a concentration ranging from about 5% to about 20%.

In a further aspect, the substrate comprises aluminum, aluminum alloy, copper, copper alloy, and combinations thereof.

In another aspect, the substrate comprises aluminum alloy 2024 T3, aluminum alloy 7075, and combinations thereof.

A further aspect is directed to an object comprising a substrate having a coating, with the coating comprising an extract derived from a plant genus comprising: Annona, Inga, Mangifera; Taraxacum; Bidens; Plantango; Chamomilla; Solidago; and combinations thereof.

In another aspect, the object comprises a substrate comprising a composition having an extract derived from a plant species comprising Annona crassiflora; Annona squamosa; Mangifera indica; Bidens pilosa; and combinations thereof, with the extract present in the composition at a concentration ranging from about 5% to about 20%.

In a further aspect, the object comprises a stationary structure, or a mobile structure, with the mobile structure including, without limitation, a vehicle.

In yet another aspect, the vehicle comprise; a manned aircraft, an unmanned aircraft; a manned spacecraft; an unmanned spacecraft; a manned rotorcraft; an unmanned rotorcraft; a manned terrestrial vehicle; an unmanned terrestrial vehicle; a manned surface marine vehicle; an unmanned marine surface vehicle; a manned sub-surface marine vehicle; an unmanned sub-surface marine vehicle, and combinations thereof.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is a graph showing the current density (A/cm²) plotted as a function of the potential applied (V) for control compound samples known to possess antioxidant behavior at a concentration of 1000 ppm;

FIG. 2 is a graph showing the polarization curves (anodic sweep) at −0.953 V during 5000 s for control compound samples known to possess antioxidant behavior at a concentration of 1000 ppm;

FIG. 3 is a graph showing the polarization curves (anodic sweep) at −0.60 V during 5000 s for control compound samples known to possess antioxidant behavior at a concentration of 1000 ppm;

FIG. 4 is a graph showing the polarization curves (anodic sweep) at −0.60 V during 5000 s for tested plant extracts at a concentration of 1000 ppm against control compound samples known to possess antioxidant behavior.

FIG. 5 is a graph showing the current density (A/cm²) plotted as a function of the potential applied (V) for control compound samples known to possess antioxidant behavior at a concentration of 1000 ppm and plant extracts at a concentration of 1000 ppm;

FIG. 6 is a graph showing a correlation plot for plant extract samples of such samples' % DPPH scavenging radical testing as a function of % Corrosion Inhibition Efficiency (% CIE); and

FIGS. 7-11 are flowcharts outlining aspects of the present disclosure.

### DETAILED DESCRIPTION

Aspects of the present disclosure are directed to anti-corrosion compositions comprising particular plant extracts from plant genera and plant species that have now been determined to possess anti-corrosion properties and characteristics. Further aspects of the disclosure are directed to coatings for substrates comprising the anti-corrosion compositions, as well as methods for inhibiting corrosion on substrate surfaces comprising applying the compositions and coatings to substrate surfaces, particularly aluminum, aluminum alloy, copper and copper alloy compositions.

It has now been determined that successful anti-corrosive coatings, also equivalently referred to herein as “corrosion inhibiting coatings”, can be made by incorporating compounds, including extracted compounds (e.g. “extracts”) from naturally occurring plant species that exhibit anti-oxidant characteristics. Many naturally occurring anti-oxidant compounds have been found to exist in, and have been extracted from various plant species. However, not every naturally occurring anti-oxidant compound candidate material will deliver adequate anti-corrosive properties to a coating formulation for the purpose of inhibiting corrosion on a particular substrate material. “Adequate anti-corrosive properties”, means anti-corrosive properties that are about equivalent to or greater than anti-corrosive properties of a non-naturally-occurring anti-corrosion formulation, such as, for example hexavalent chromium-containing compounds.

Indeed, while many naturally occurring plant genera, and species within such genera, may display some degree of anti-oxidant characteristic, it has been determined that not all such genera and species will produce extracts that contribute a sufficient degree of anti-corrosion properties to an anti-corrosion formulation for the purpose of inhibiting corrosion including, without limitation, inhibiting corrosion on a substrate comprising aluminum or an aluminum alloy, copper or a copper alloy, etc. Therefore, significant labor-intensive trial and error effort can be expended to obtain a requisite effective amount of extract from a candidate plant genus or plant species for inclusion into an anti-corrosion formulation to protect a substrate in terms of protection from corrosion, only to discover that such anti-corrosion formulation produces a sub-standard degree of corrosion protection for substrate materials such as, for example, aluminum, aluminum alloys, copper, copper alloys etc.

According to the present disclosure, methods now have been discovered for predictively selecting plant extracts from plant genera and plant species that will provide predetermined and quantifiable anti-corrosive properties to an anti-corrosion formulation for the purpose of inhibiting corrosion of a substrate. Preferably, the substrate comprises aluminum, an aluminum alloy, copper, a copper alloy, etc.

DPPH (diphenylpiccrylhydrazyl) is a stable and commercially available organic nitrogen radical, and has a UV—visible absorption maximum at 517 nm. Upon reduction, the purple solution color of the DPPH solution fades, enabling the reaction to be monitored colorometrically by a spectrophotometer. The loss of the solution's starting purple color towards a yellowish color is an indication that the solution's antioxidant capacity (i.e. radical scavenging) has increased. The antioxidant capacity (i.e. radical scavenging) is therefore expressed as the inhibition percentage (%) of the DPPH. A spectrophotometer measures the absorptions of the DPPH solution of blanks/controls and with samples. The absorption value of the blank DPPH solution minus the tested solution (samples) will yield the amount of the radicals scavenged.

According to the present disclosure, selected plants were tested in a DPPH assay, and were then submitted for Linear Sweep Voltammetry and Chronoamperometry analyses. A collection of compounds possessing known characteristics were sampled as “controls” to produce reference points. For example, thiophenol, possessing a thiol group, was known to possess satisfactory corrosion inhibition and was used as a control in the electrochemical tests. According to the present disclosure, at a potential held at −0.6V, plant extract samples found to be useful as additives for corrosion inhibition formulations applied to substrate (and that were tested at concentrations ranging from 1 ppm to 1000 ppm) showed particularly good results at concentrations ranging from about 500 ppm to about 1000 ppm as compared with the thiophenol and other control reference points.

According to the present disclosure, plants, including plants that are found abundantly in nature that are thought to possess some degree of anti-oxidant capacity were identified and collected. More specifically, five (5) species from the Asteraceae family, three (3) from the Annonaceae family, one (1) from the Astropurpurea family, one (1) from the Eurphorbiaceae family were harvested, separated into leaves, branch, fruit, pulp, peel and seeds, and then submitted to an extraction process.

A further contemplated aspect of obtaining a plant extract contemplates extracting the plant extract sample by a method comprising: treating plant seeds, plant pulp, plant peel or combinations thereof to obtain a sample; adding a solvent to the sample; and precipitating a dried extract from the solvent. It is understood that the solvent is substantially removed from the sample. “Treating” a sample includes any chemical or physical processes that can be effected to reduce a natural plants form (e.g. seeds, leaf, peel, etc.) to a reduced form. Such “treatments include, without limitation, macerating, pulverizing, etc. It is further understood that macerating a sample refers to the process of softening or breaking down the sample, typically by the addition of a solvent.

Further extraction processes were conducted as follows. Aerial parts of Bidens pilosa, Taraxacum officinale and Chamomilla recutida, seeds and peel of Annona crassiflora, and leaves of Mangifera indica and Solidago were frozen in liquid nitrogen, pulverized and freeze-dried before extraction. The extracts were obtained by extracting the plant material with a polar organic solvent such as alcohol, methanol or ethanol, and ethanol mixed with water (otherwise referred to equivalently as ethanol 70%, and ethanol:water, 7:3 (v/v)). One (1.0 g) gram of plant material was extracted with three (3.0) mL of methanol under agitation for 20 minutes. The extraction was performed three times. The resultant combined liquid extract was evaporated under vacuum at 45° C. The extracts obtained were kept out of light under 4° C. For Annona squamosa peel, the best solvent extractor was a solution of ethanol/water (7:3), otherwise referred to as ethanol 70% v/v. One (1.0 g) gram of plant material was extracted with three (3.0) mL of ethanol 70% v/v under agitation for 20 minutes. The extraction was performed three times. The resultant combined liquid extract was evaporated under vacuum at 50° C. The water residual was frozen-dried and the extract was kept out of light under 4° C.

Thirty-seven (37) plant extracts from five (5) different plant species were conducted by performing a diphenylpicrylhydrazyl (DPPH) radical scavenging assay. Such DPPH assay is based on the ability of the assay to transfer an electron from an anti-oxidant-containing compound to an oxidant. Three plant samples presenting more than 60% of efficiency in DPPH radical scavenging were selected as potential antioxidant sources. In addition, thiophenol, 2,5-dimercapto-1,3,4-thiadiazole and 6-amino-2-mercaptobenzothiazole were also evaluated and established as controls in the DPPH radical scavenging assay, and showed 90.69%; 88.55% and 88.42% respectively of radical scavenging capacity. Alpha tocopherol (Vitamin E), ascorbic acid (Vitamin C) and gallic acid were also used as positive controls and showed 90.17%; 89.01% and 88.80% of radical scavenging, respectively.

It has now been determined that, correlating the results obtained for plant extract samples subjected to: 1) DPPH assays, and also 2) electrochemical techniques (Linear Sweep Voltammetry and Chronoamperometry analyses) to determine corrosion can accurately predict the efficacy of candidate materials as to their ability to impart anti-corrosive properties to an anti-corrosion formulation for use on substrate materials comprising aluminum, aluminum alloy, copper and copper alloy.

While the specific results obtained for samples subjected to: 1) DPPH radical scavenging assays, and also 2) electrochemical techniques (Linear Sweep Voltammetry and Chronoamperometry analyses) may vary, it has been determined that when a particular extract displays approximately a 1:1 (+/−10%) correlation between the values, and the values are about 80.00 or higher, the plant extract possesses corrosion inhibition characteristics that can be implemented into a corrosion inhibition formulation for aluminum and aluminum alloy substrates to inhibit corrosion of substrates comprising aluminum, aluminum alloy, copper and copper alloy.

### Examples 1-7

The compounds thiophenol, 2,5-dimercapto-1,3,4-thiadiazole and 6-amino-2-mercaptobenzothiazole having anticorrosive properties were used as controls. Additionally, alpha-tocopherol, ascorbic acid and gallic acid (Sigma-Aldrich) were used as standard compounds having known and recognized antioxidant activity.

DPPH Radical Scavenging Assay—The antioxidant test (Erkin, Cetin, and Ayranci, 2011; Roesler, Carharino, Malta, Eberlin & Pastore, 2007) was conducted in Thermo Scientific Spectrophotometer (Multiskan GO processed by Skanit Software 3.2.1.4RE). The assay was performed on 96-well microplates with six (6) different concentrations of each substance (1000, 500, 250, 125, 62.5 and 31.25 μg/mL). A DPPH methanol solution (250 μL) 0.004% (w/v) was added t a methanol solution of the compound to be tested (10 μL). Absorbance at 517 nm was determined after 30 mins. The control was prepared as above without any extract, and methanol was used for the baseline correction. Radical scavenging was expressed as the inhibition percentage and was calculated via the formula:

% corrosion inhibition=[(A_{DPPH}−A_{Ext})/A_{DPPX}]×0.100

wherein A_{DPPH} is the absorbance value of a DPPH blank sample; A_{Ext} is the absorbance value of the extract sample evaluated as the difference between the absorbance value of the extract sample and the absorbance value of a corresponding blank.

Rotating Disk Experiments—Linear Sweep Voltammetry (LSV) was conducted on a Pine Research Instrument using a rotating coper disk electrode rotator at 1000 rpm with a Series G-750 potentionstat, with a platinum counter electrode and glass Colonel Ag/AgCl reference electrode. Gamry Framework software was used. A copper disk (1 cm²) working electrode (OD 10 mm) was used with the electrode polished between readings. LSV was measured as an electrical potential scan was performed between −0.157V and −1.150V with a scan rate of 0.002V/s. Air was introduced via pump into the solution before the measurements. The current decay values were determined at −0.953V over 5000 seconds. It was observed that the current plateau was situated between −0.7 and −0.6V for the majority of the commercial (known) compounds. As the current plateau can be an indication of the inhibitor corrosion function, chronoamperometry experiments were run at a potential maintained at −0.6V. Solutions were prepared with phosphate buffered saline (PBS) buffer tablets (Sigma P4417). Purity of the 99%+ pure copper was verified using a Baird DV4 Arc/Spark optical emission spectrometer. Two different experiments were performed:

1. Measurement of current according to the potential applied in the range of −0.157V to −1.150V;

2. Polarization curves (Anodic sweep) at −0.953V during 5000 s and −0.6V, decay of current v. time.

The initial experiments were conducted at the following concentrations: 1000, 500, 100 and 10 ppm. The experiments with the potential held at −0.6V were performed at 1000 ppm. Before each set of experiments, a blank sample (100 mL of PBS) was performed.

The Corrosion Inhibition Efficiency Percentage (% CIE) was calculated using the following formula:

% CIE=[1−i(w/inhibitor)(S)/i(w/o inhibitor)(B)×100,

wherein % CIE is corrosion inhibition efficiency percentage; I (w/inhibitor)(S) is the current measured at 5000 s for the extract sample in determined potential; I (w/o inhibitor)(B) is the current measured at 5000 s for a corresponding blank sample, said blank sample comprising 100 mL of phosphate buffer solution.

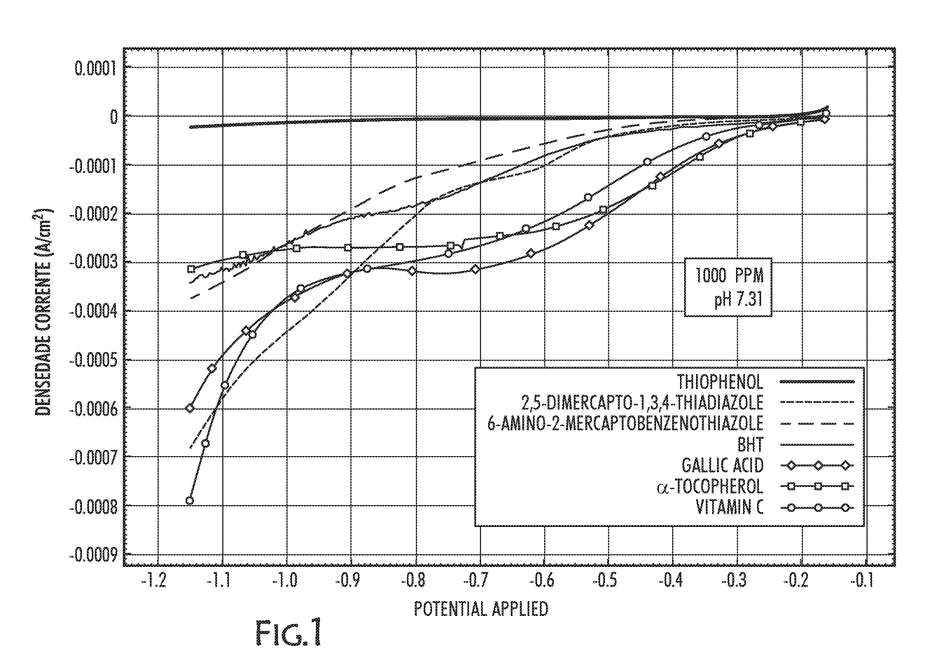

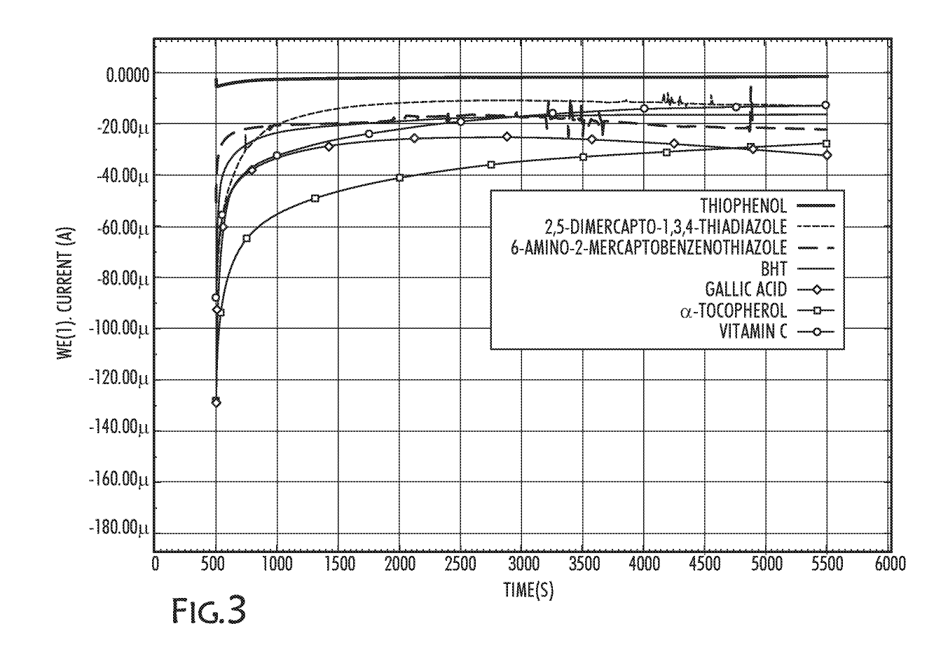

FIGS. 1-3 show results of the evaluation of the above-identified control materials. Steady state chronoamperometry was used with the potentiostat maintained at −0.800V with the current measured over time. See FIG. 3. The procedure used was as follows. Calibrated and polished copper, aluminum and platinum disk working electrodes were provided having a dimension of 11.3 mm OD×1.5 mm thick. A 150 mL beaker was clamped into place and filled with 5% NaCl solution with phosphate buffered saline (Sigma Aldrich—P4417-100TAB; 0.137M, 0.8% NaCl and 0.01M phosphate buffer, 0.0027M potassium chloride. The platinum wire reference electrode was rinsed with deionized water, wiped, and clamped to a side of the beaker. Potentiostat working electrode cables were connected to the rotating disk rotator, ensuring that electrodes were not touching one another in the beaker. The speed was adjusted to 1000 rpm and turned on. Blank electrolytes and solutions with known concentrations of corrosion inhibitors were run for verification.

Aspects of the present disclosure employ a copper rotating disk electrode. The copper rotating disk electrode enables an assay that observes oxygen reductions that are occurring. While being bound to no particular theory, it is believed that the use of a copper rotating disk electrode is important for determining anti-corrosion potential of a candidate material for use with aluminum and aluminum alloy substrates, because copper is a key element involved in the dynamics of aluminum corrosion. Prior analyses for anti-corrosion employed electrodes (e.g. steel electrodes) that would not discern the appropriate likelihood of anti-corrosiveness of compounds for use with aluminum and aluminum alloy substrates. For example, while potassium phosphate is known to prevent corrosion on aluminum components, the known assaying tests for % CIE would yield a negative result for potassium phosphate due to the use of a steel electrode.

Thiophenol and 6-amino-2-mercaptobenzothiazole were reported to provide corrosion inhibition in aluminum alloys (Vukmirovic et al., 2003), and also DPPH scavenging activity at 1000 ppm (90.69% AND 88.42%, respectively). Further, 2,5-dimercapto-1,3,4-thiadiazole was known in the aluminum corrosion literature (showing poor performance for corrosion inhibition in immersion procedure—ASTM G31-72). However, 2,5-dimercapto-1,3,4-thiadiazole showed good DPPH radical scavenging activity at sample concentrations of 250, 500 and 1000 ppm (74.81%, 83% and 83.5%, respectively). Butylated hydroxytoluene (BHT) is known to be a powerful synthetic antioxidant. BHT showed good % of DPPH radical scavenging at 250, 500 and 1000 ppm (69%, 85% and 89%, respectively). Gallic acid, alpha-tocopherol and ascorbic acid were used as positive controls in the DPPH antioxidant test. See Table 1, Examples 1A-7B.

### Examples 8-39

Eight (8) species were harvested and submitted to an extraction process. Different solvents and solvent mixtures were evaluated, with methanol selected as the optimum solvent. Thirty-seven (37) plant extracts from five (5) different species of plants were conducted in the DPPH radical scavenging assay. The inhibition percentage (%) of the DPPH for samples tested (500 ppm and 1000 ppm) is presented in the Table 1 above. Corrosion Inhibition Efficiency Percentage (% CIE) was then tested by subjecting the plant extract samples to Linear Sweep Voltammetry and chronoamperometry experiments, with the results of both % DPPH and % CIE for the plant samples and control samples presented in Table 2 below.

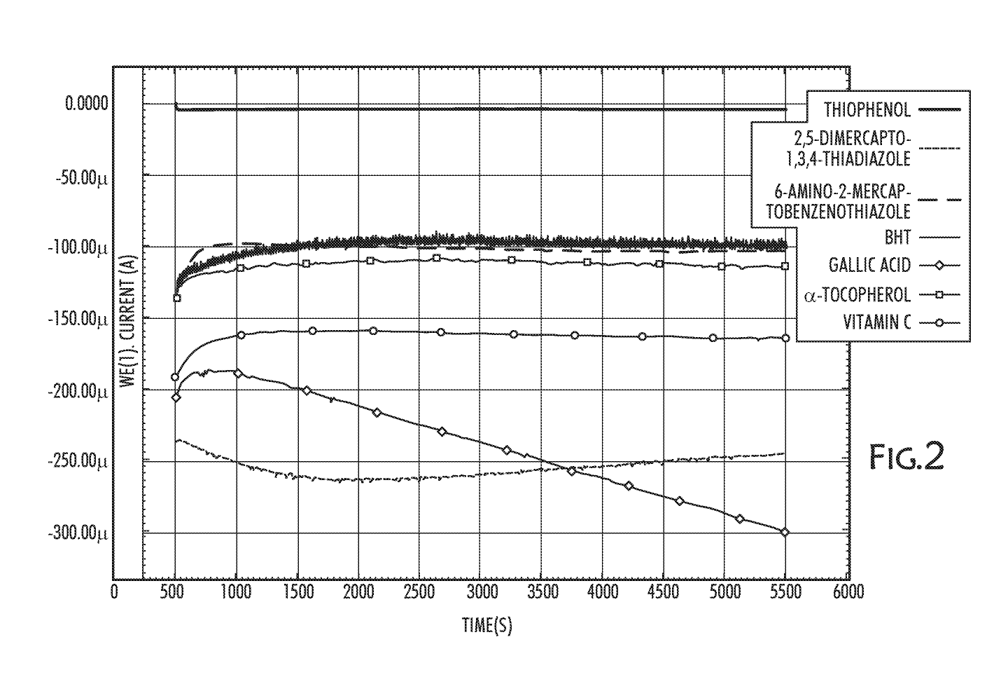

Thiophenol, 2,5-dimercapto-1,3,4-thiadiazole, 6-amino-2-mercaptobenzothiazole, alpha tocopherol (Vitamin E), butylated hydroxytoluene, ascorbic acid (Vitamin C) and gallic acid were evaluated as known corrosion inhibition controls in Linear Sweep Voltammetry and chronoamperometry experimentation. Current variation curves are presented in FIG. 1 showing the potential applied. Chronoamperometry experiments were conducted at a potential maintained at −0.953 V, with results shown in FIG. 2. The current density (A/cm²) plotted as a function of the potential applied (V) for the inhibitors at a concentration of 1000 ppm. The plotted results showed that no plateau existed at a potential of −0.953 V for the inhibitors tested, except for thiophenol.

The potential was changed and an anodic sweep curve was obtained with the potential maintained at −0.70 V (see FIG. 3). When it was observed that some compounds had a plateau closer to −0.60 V, new experiments were conducted at a potential maintained at −0.60 V.

Seeds, pulp and peels of Annona crassiflora and Annona squamosa fruits were separated, frozen and freeze dried. Seeds were pulverized using pre-cooled mortar and pestle under liquid nitrogen. The frozen powder was transferred to tubes and freeze-dried for two days. The weighed material was successively extracted by maceration with hexane and ethanol (70% v/v) under sonication for 20 minutes. Maceration is understood to be the process by which a solid is softened or separated into constituents by soaking in a liquid, such as, for example a solvent. The seeds/solvent rate was 1:3 (w/v). The solvent was removed under reduced pressure (700 mm Hg, vacuum pump)) using a rotoevaporator. The resultant hexane extract was obtained in the form of pale yellowish oil, yielding 31.5% dry weight. The ethanolic extract was obtained in the form a brown-colored syrup, yielding 14% of dry weight. Peels of Annona crassiflora and Annona squamosa fruit, after pulverization and freeze-drying, were extracted by maceration with ethanol 75% under sonication for 20 minutes. The peel/solvent rate was 1:3 (w/v). The solvent was removed under pressure (700 mm Hg, vacuum pump) using a rotoevaporator. The resultant Annona crassiflora peel extract was obtained in the form of a dark-colored syrup yielding 22.4% dry weight. The resultant Annona squamosa peel extract was obtained in the form of a dark colored syrup yielding 20.2% dry weight.

Leaves of Inga sp. were pulverized using pre-cooled pestle and mortar under liquid nitrogen, the frozen powder was transferred to tubes and freeze-dried for two days. The weighed material was extracted with methanol (MeOH) under sonication for 20 minutes. After the solvent removal under reduced pressure, the leaf methanolic extract was obtained. The leaf extracts were maintained under dark refrigeration at 4° C.

The extracts obtained were screened on DPPH Radical Scavenger assays. The extracts obtained were screened on DPPH Radical Scavenger assays. The antioxidant test (Erkan, Cetin., & Ayranci. 2011; Roesler, Catharino, Malta, Eberlin, & Pastore, 2007) was carried out on 96-well microplates with five different concentrations of each substance (500, 250, 125, 62.5 and 31.25 μg/mL). A DPPH MeOH solution (250 μL) 0.004% (w/v) was added to a MeOH solution of the compound to be tested (10 μL). Absorbance at 492 nm was determined after 30 min. The control was prepared as above without any extract, and methanol was used for the baseline correction. Radical scavenging was expressed as the inhibition percentage and was calculated using the following formula

% Inhibition=[(A_{DPPH}−Aₑₓₜ)/A_{DPPH}]·100

where ADPPH is the absorbance value of the DPPH′ blank sample and AExt is the absorbance value of the test solution. AExt was evaluated as the difference between the absorbance value of the test solution and the absorbance value of its blank. The % IC values are reported in final concentration of 500 μg/mL of dried extracts and isolated compounds.

It would be understood by those skilled in the field that the accepted “shorthand” listing of various plant species acceptably lists the genus in abbreviated fashion, such that, for example, A. crassiflora is an equivalent term for Annona crassiflora, etc. Further EtOH is an equivalent chemical “shorthand” for ethanol, and MeOH is an equivalent “shorthand” for methanol. Extracts in an amount of 10 g each were obtained from five (5) plants as follows:
1 —Annona crassiflora—Seed extract
2 —Annona crassiflora—Peel extract
3 —Inga spp—Leaf extract
4 —Mangifera indica—Leaf extract
5 —Annona squamosa—Peel extract

### Control Examples 1A and 1B

| | Conc. | |
|---|---|---|
| Extract Type | (ppm) | (% CIE) |
| 1A. Thiophenol | 500 | 89.40 |
| 1B. Thiophenol | 1000 | 90.69 |

### Control Examples 2A and 2B

| | Conc. | |
|---|---|---|
| Extract Type | (ppm) | (% CIE) |
| 2A. 2,5-dimercapto-1,3,4-thiadiazole | 500 | 88.89 |
| 2B. 2,5-dimercapto-1,3,4-thiadiazole | 1000 | 88.55 |

### Control Examples 3A and 3B

| | Conc. | |
|---|---|---|
| Extract Type | (ppm) | (% CIE) |
| 3A. 6-amino-2-mercaptobenzothiazole | 500 | 88.69 |
| 3B. 6-amino-2-mercaptobenzothiazole | 1000 | 88.42 |

### Control Examples 4A and 4B

| | Conc. | |
|---|---|---|
| Extract Type | (ppm) | (% CIE) |
| 4A. ascorbic acid (Vitamin C) | 500 | 91.40 |
| 4B. ascorbic acid (Vitamin C) | 1000 | 92.40 |

### Control Examples 5A and 5B

| | Conc. | |
|---|---|---|
| Extract Type | (ppm) | (% CIE) |
| 5A. alpha tocopherol (Vitamin E) | 500 | 91.08 |
| 5B. alpha tocopherol (Vitamin E) | 1000 | 90.96 |

### Control Examples 6A and 6B

| | Conc. | |
|---|---|---|
| Extract Type | (ppm) | (% CIE) |
| 6A. butylated hydroxytoluene (BHT) | 500 | 78.13 |
| 6B. butylated hydroxytoluene (BHT) | 1000 | 87.17 |

### Control Examples 7A and 7B

| | Conc. | |
|---|---|---|
| Extract Type | (ppm) | (% CIE) |
| 7A. gallic acid | 500 | 90.42 |
| 7B. gallic acid | 1000 | 90.72 |

### Examples 8A and 8B

| | Conc. | | |
|---|---|---|---|
| Extract Type | (ppm) | Solvent | (% CIE) |
| 8A. Annona crassiflora (Seeds) | 500 | MeOH 100% | 17.25 |
| 8B. Annona crassiflora (Seeds) | 1000 | MeOH 100% | 78.39 |

### Examples 9A and 9B

| | Conc. | | |
|---|---|---|---|
| Extract Type | (ppm) | Solvent | (% CIE) |
| 9A. Annona crassiflora (Seeds) | 500 | EtOH/H₂0 (7:3) | 19.20 |
| 9B Annona crassiflora (Seeds) | 1000 | EtOH/H₂0 (7:3) | 40.75 |

### Examples 10A and 10B

| | Conc. | | |
|---|---|---|---|
| Extract Type | (ppm) | Solvent | (% CIE) |
| 10A. Annona crassiflora (Seeds) | 500 | EtOH/H₂0 (1:1) | 33.40 |
| 10B. Annona crassiflora (Seeds) | 1000 | EtOH/H₂0 (1:1) | 54.85 |

### Examples 11A and 11B

| | Conc. | | |
|---|---|---|---|
| Extract Type | (ppm) | Solvent | (% CIE) |
| 11A. Bidens pilosa (Leaves) | 500 | MeOH 100% | 70.60 |
| 11B. Bidens pilosa (Leaves) | 1000 | MeOH 100% | 85.05 |

### Examples 12A and 12B

| | Conc. | | |
|---|---|---|---|
| Extract Type | (ppm) | Solvent | (% CIE) |
| 12A. Bidens pilosa (Leaves) | 500 | EtOH/H₂0 (7:3) | 17.40 |
| 12B. Bidens pilosa (Leaves) | 1000 | EtOH/H₂0 (7:3) | 51.81 |

### Examples 13A and 13B

| | Conc. | | |
|---|---|---|---|
| Extract Type | (ppm) | Solvent | (% CIE) |
| 13A. Bidens pilosa (Leaves) | 500 | EtOH/H₂0 (1:1) | 16.29 |
| 13B. Bidens pilosa (Leaves) | 1000 | EtOH/H₂0 (1:1) | 38.05 |

### Examples 14A and 14B

| | Conc. | | |
|---|---|---|---|
| Extract Type | (ppm) | Solvent | (% CIE) |
| 14A. Taraxacum officianalle | 500 | MeOH 100% | 14.98 |
| 14B. Taraxacum officianalle | 1000 | MeOH 100% | 30.45 |

### Examples 15A and 15B

| | Conc. | | |
|---|---|---|---|
| Extract Type | (ppm) | Solvent | (% CIE) |
| 15A. Taraxacum officianalle | 500 | EtOH/H₂0 (7:3) | −1.49 |
| 15B. Taraxacum officianalle | 1000 | EtOH/H₂0 (7:3) | 66.67 |

### Examples 16A and 16B

| | Conc. | | |
|---|---|---|---|
| Extract Type | (ppm) | Solvent | (% CIE) |
| 16A. Taraxacum officianalle | 500 | EtOH/H₂0 (1:1) | 27.32 |
| 16B. Taraxacum officianalle | 1000 | EtOH/H₂0 (1:1) | 42.41 |

### Examples 17A and 17B

| | Conc. | | |
|---|---|---|---|
| Extract Type | (ppm) | Solvent | (% CIE) |
| 17A. Annona squamosa (Seeds) | 500 | MeOH 100% | 15.10 |
| 17B. Annona squamosal (Seeds) | 1000 | MeOH 100% | 48.54 |

### Examples 18A and 18B

| | Conc. | | |
|---|---|---|---|
| Extract Type | (ppm) | Solvent | (% CIE) |
| 18A. Annona squamosa (Peel) | 500 | MeOH 100% | 79.66 |
| 18B. Annona squamosa (Peel) | 1000 | MeOH 100% | 87.66 |

### Examples 19A and 19B

| | Conc. | | |
|---|---|---|---|
| Extract Type | (ppm) | Solvent | (% CIE) |
| 19A. Annona squamosa (Peel) | 500 | MeOH/H₂0 (7:3) | 89.55 |
| 19B. Annona squamosa (Peel) | 1000 | MeOH/H₂0 (7:3) | 88.41 |

### Examples 20A and 20B

| | Conc. | | |
|---|---|---|---|
| Extract Type | (ppm) | Solvent | (% CIE) |
| 20A. Annona squamosa (Peel) | 500 | MeOH/H₂0 (1:1) | 89.12 |
| 20B. Annona squamosa (Peel) | 1000 | MeOH/H₂0 (1:1) | 86.21 |

### Examples 21A and 21B

| | Conc. | | |
|---|---|---|---|
| Extract Type | (ppm) | Solvent | (% CIE) |
| 21A. Annona squamosa (Peel) | 500 | EtOH/H₂0 (1:1) | 84.79 |
| 21B. Annona squamosa (Peel) | 1000 | EtOH/H₂0 (1:1) | 86.90 |

### Examples 22A and 22B

| | Conc. | | |
|---|---|---|---|
| Extract Type | (ppm) | Solvent | (% CIE) |
| 22A. Annona squamosa (Peel) | 500 | EtOH/H₂0 (7:3) | 87.85 |
| 22B. Annona squamosa (Peel) | 1000 | EtOH/H₂0 (7:3) | 88.40 |

### Examples 23A and 23B

| | Conc. | | |
|---|---|---|---|
| Extract Type | (ppm) | Solvent | (% CIE) |
| 23A. Annona crassiflora (Peel) | 500 | MeOH 100% | 40.82 |
| 23B. Annona Crassiflora (Peel) | 1000 | MeOH 100% | 52.80 |

### Examples 24A and 24B

| | Conc. | | |
|---|---|---|---|
| Extract Type | (ppm) | Solvent | (% CIE) |
| 24A. Annona crassiflora (Peel) | 500 | EtOH 100% | 32.40 |
| 24B. Annona crassiflora (Peel) | 1000 | EtOH 100% | 51.65 |

### Examples 25A and 25B

| | Conc. | | |
|---|---|---|---|
| Extract Type | (ppm) | Solvent | (% CIE) |
| 25A. Annona crassiflora (Peel) | 500 | EtOH/H₂0 (7:3) | 73.80 |
| 25B. Annona crassiflora (Peel) | 1000 | EtOH/H₂0 (7:3) | 91.73 |

### Examples 26A and 26B

| | Conc. | | |
|---|---|---|---|
| Extract Type | (ppm) | Solvent | (% CIE) |
| 26A. Annona crassiflora (Peel) | 500 | MeOH 100% | 57.91 |
| 26B. Annona crassiflora (Peel) | 1000 | MeOH 100% | 82.76 |

### Examples 27A and 27B

| | Conc. | | |
|---|---|---|---|
| Extract Type | (ppm) | Solvent | (% CIE) |
| 27A. Annona crassiflora (Peel) | 500 | EtOH 100% | 75.70 |
| 27B. Annona crassiflora (Peel) | 1000 | EtOH 100% | 87.70 |

### Examples 28A and 28B

| | Conc. | | |
|---|---|---|---|
| Extract Type | (ppm) | Solvent | (% CIE) |
| 28A. Annona crassiflora (Peel) | 500 | EtOH/H₂0 (7:3) | 87.37 |
| 28B. Annona crassiflora (Peel) | 1000 | EtOH/H₂0 (7:3) | 88.01 |

### Examples 29A and 29B

| | Conc. | | |
|---|---|---|---|
| Extract Type | (ppm) | Solvent | (% CIE) |
| 29A. Annona crassiflora (Peel) | 500 | MeOH 100% | 85.88 |
| 29B. Annona crassiflora (Peel) | 1000 | MeOH 100% | 87.64 |

### Examples 30A and 30B

| | Conc. | | |
|---|---|---|---|
| Extract Type | (ppm) | Solvent | (% CIE) |
| 30A. Annona crassiflora (Peel) | 500 | EtOH 100% | 46.39 |
| 30B. Annona crassiflora (Peel) | 1000 | EtOH 100% | 77.78 |

### Examples 31A and 31B

| | Conc. | | |
|---|---|---|---|
| Extract Type | (ppm) | Solvent | (% CIE) |
| 31A. Annona crassiflora (Peel) | 500 | EtOH/H₂0 (7:3) | 88.01 |
| 31B. Annona crassiflora (Peel) | 1000 | EtOH/H₂0 (7:3) | 88.54 |

### Examples 32A and 32B

| | Conc. | | |
|---|---|---|---|
| Extract Type | (ppm) | Solvent | (% CIE) |
| 32A. Annona crassiflora (Peel) | 500 | MeOH 100% | 38.15 |
| 32B. Annona crassiflora (Peel) | 1000 | MeOH 100% | 73.02 |

### Examples 33A and 33B

| | Conc. | | |
|---|---|---|---|
| Extract Type | (ppm) | Solvent | (% CIE) |
| 33A. Annona crassiflora (Peel) | 500 | EtOH 100% | 87.47 |
| 33B. Annona crassiflora (Peel) | 1000 | EtOH 100% | 88.51 |

### Examples 34A and 34B

| | Conc. | | |
|---|---|---|---|
| Extract Type | (ppm) | Solvent | (% CIE) |
| 34A. Annona crassiflora (Peel) | 500 | EtOH/H₂0 (7:3) | 64.60 |
| 34B. Annona crassiflora (Peel) | 1000 | EtOH/H₂0 (7:3) | 88.62 |

### Examples 35A and 35B

| | Conc. | | |
|---|---|---|---|
| Extract Type | (ppm) | Solvent | (% CIE) |
| 35A. Chamomilla recutita | 500 | MeOH 100% | 19.68 |
| 35B. Chamomilla recutita | 1000 | MeOh 100% | 37.99 |

### Examples 36A and 36B

| | Conc. | | |
|---|---|---|---|
| Extract Type | (ppm) | Solvent | (% CIE) |
| 36A. Solidago | 500 | MeOH 100% | 5.44 |
| 36B. Solidago | 1000 | MeOh 100% | 24.89 |

The following three (3) plant extracts showed good DPPH radical scavenging activity at 1000 ppm (with “good” DPPH assay understood to be DPPH radical scavenging assay activity>85%): Bidens pilosa, Annona crassiflora, and Annona squamosa. Bidens pilosa leaves and branches extracted with methanol and the methanolic extract at 1000 ppm showed an antioxidant activity of 85.05%. The fruit from Annona crassiflora was separated into seeds, pulp and peels and extracted with methanol and showed the antioxidant activity presented in Tables 1 and 2.

The results of the best-performing plant extracts in terms of: 1) high % DPPH Radical Scavenging test results (greater than about 80%); and 2) high % CIE percentage are listed below in Table 2, along with the performance of the various control compounds (for comparison) known to possess a requisite level of corrosion inhibition [thiophenol, 2,5-dimercapto-1,3,4-thiadiazole, 6-amino-2-mercaptobenzothiazole, alpha tocopherol (Vitamin E), butylated hydroxytoluene (BHT), ascorbic acid (Vitamin C), and gallic acid].

As shown in Table 2, plant extract samples of Bidens pilosa, A. squamosa peel, and A. crassiflora peel at a concentration of 1000 ppm all generated % DPPH values and % CIE values exceeding 80%.

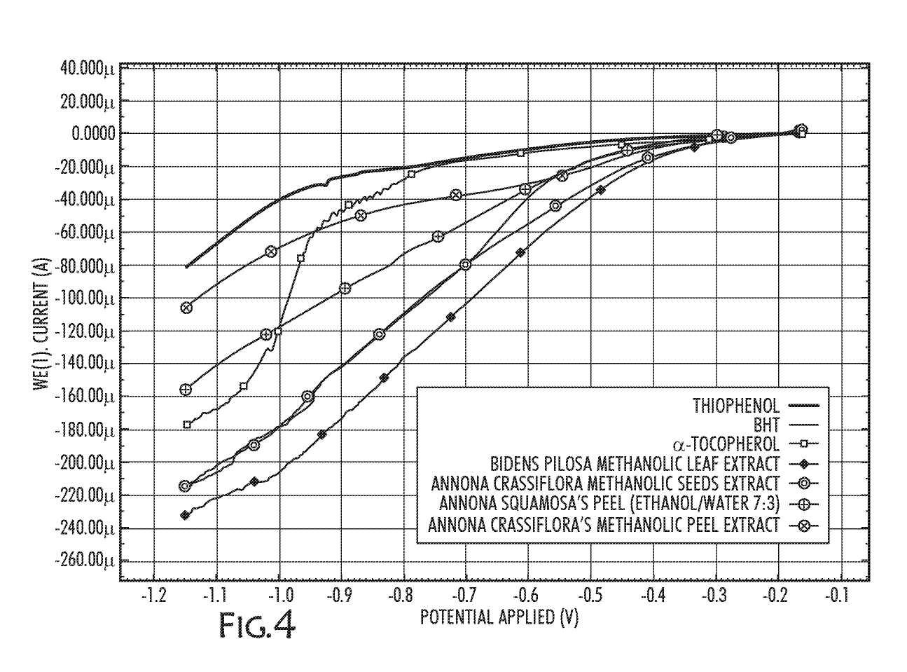

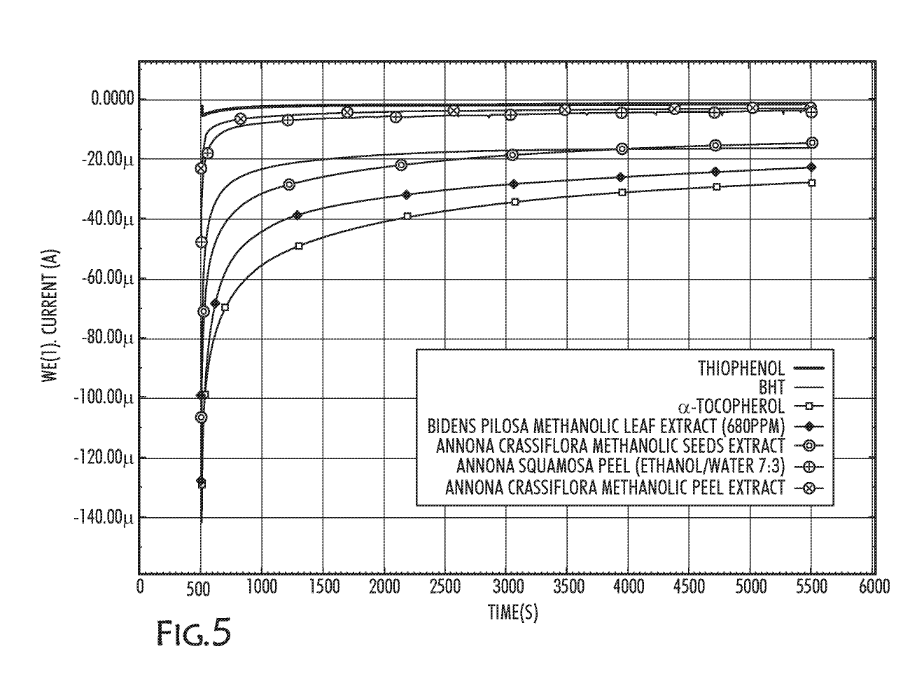

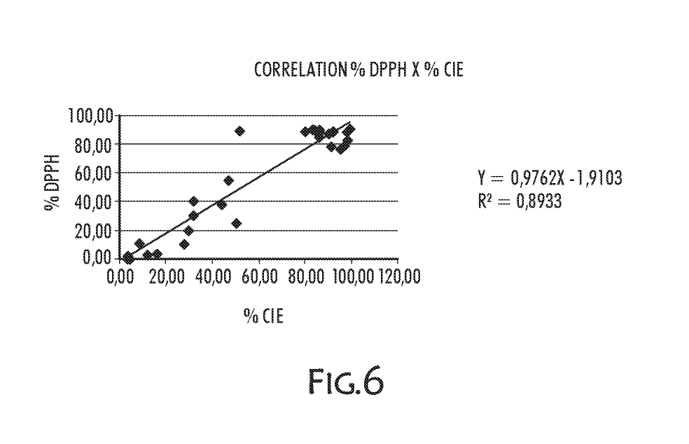

FIG. 4 is a graph showing the polarization curves (anodic sweep) at −0.60 V during 5000 s for tested plant extracts at a concentration of 1000 ppm against control compound samples known to possess antioxidant behavior. FIG. 5 is a graph showing the current density (A/cm²) plotted as a function of the potential applied (V) for control compound samples known to possess antioxidant behavior at a concentration of 1000 ppm and plant extracts at a concentration of 1000 ppm. FIG. 6 is a graph showing a correlation plot for plant extract samples' % DPPH scavenging radical testing as a function of % Corrosion Inhibition Efficiency (% CIE).

The extract samples shown below in Table 3 were dissolved in methanol at concentrations of 5% and 20% and then incorporated into a primer formulation as follows: 8 parts Duxone DXPU polyurethane; 1 part Duxone DX700 catalyzer. Duxone DX 700 solvent thinner was also added. (Duxone products are made by DuPont). Solids were removed via filtration on sieves. A primer comprising a sol-gel (Desogel EAP-9 (Gol Airlines)) was used to coat aluminum 2024 T3 panels. The panels were then coated with the extract formulations by painting. For reference, a formulation of Vanlube 829 (RT Vanderbilt Co.) at a concentration of 20% was also prepared. Aluminum 2024 T3 panels were coated with the Vanlube 829 by painting. The panels were then prepared for scratch testing according to ASTM D7091-13. After salt spray testing (ASTM B117) for 336 hours, the Aluminum panels coated with the extract/primer formulation samples containing Annona crassiflora peal extract and Mangifera indica leaf extract appeared visually and after scanning electron microscopy (SEM) to have protected the panels from corrosion to an extent substantially similarly to the panels coated with the Vanlube 829. Extract samples of Mangifera indica were obtained via the methods and protocols set forth herein used to obtain the other plant extract samples. The test results for the 5% Salt Spray Testing of panels conditioned via scratch test ASTM 1654 are shown below in Table 3. Each of the extracts tested and reported in Table 3 above represented more than 85% of corrosion inhibition efficiency.

TABLE 3
Salt Spray Corrosion Test Matrix and Results

| | Concen- | | | |
|---|---|---|---|---|
| | tration | 96-hr | 336-hr | 1000-hr |
| Inhibitor | % | Ranking | Ranking | Ranking |
| Annona crassiflora - Seed Extract | 20 | 2 | 1 | 3 |
| Annona crassiflora - Peel Extract | 5 | 8 | 7 | 7 |
| | 20 | 7 | 6 | 5 |
| Inga sp - Leaf Extract | 5 | 5 | 5 | 9 |
| | 20 | 11 | 12 | 12 |
| Mangifera indica | 5 | 12 | 11 | 10 |
| | 20 | 4 | 4 | 11 |
| Annona squamosal - Peel Extract | 5 | 9 | 8 | 6 |
| | 20 | 10 | 10 | 8 |
| Vanlube 829 | 20 | 1 | 2 | 1 |

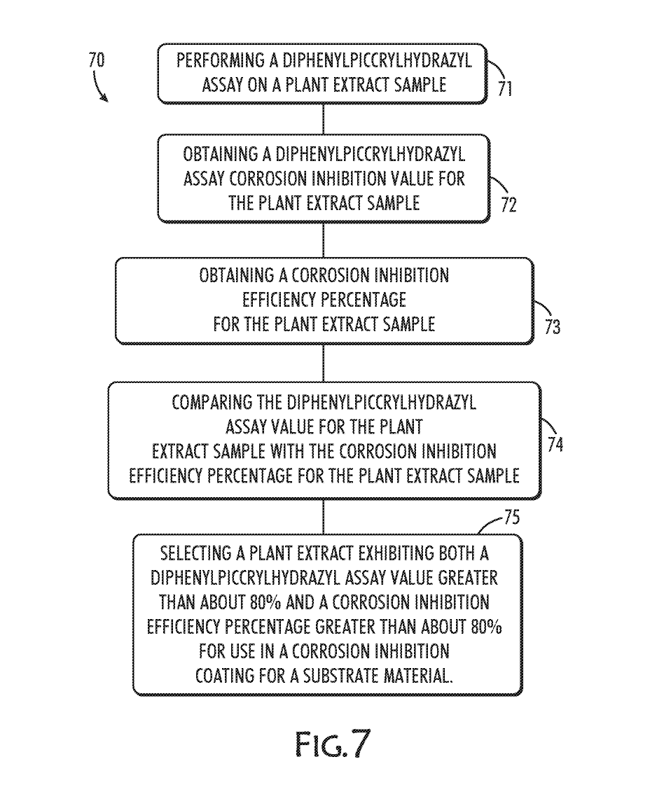

FIGS. 7-10 are flowcharts outlining aspects of the present disclosure. According to one aspect of the present disclosure, FIG. 7 outlines a predictive method 70 for selecting a plant extract having a requisite level of corrosion inhibition for aluminum and aluminum alloys comprising performing a diphenylpiccrylhydrazyl (DPPH) radical scavenging assay on a plant extract sample 71, obtaining a diphenylpiccrylhydrazyl (DPPH) radical scavenging assay corrosion inhibition value for the plant extract sample 72, obtaining a corrosion inhibition efficiency percentage for the plant extract sample 73, comparing the diphenylpiccrylhydrazyl (DPPH) radical scavenging assay value for the plant extract sample with the corrosion inhibition efficiency percentage for the plant extract sample 74, and selecting a plant extract exhibiting both a diphenylpiccrylhydrazyl (DPPH) radical scavenging assay value greater than about 80% and a corrosion inhibition efficiency percentage greater than about 80% for use in a corrosion inhibition coating for a substrate material 75.

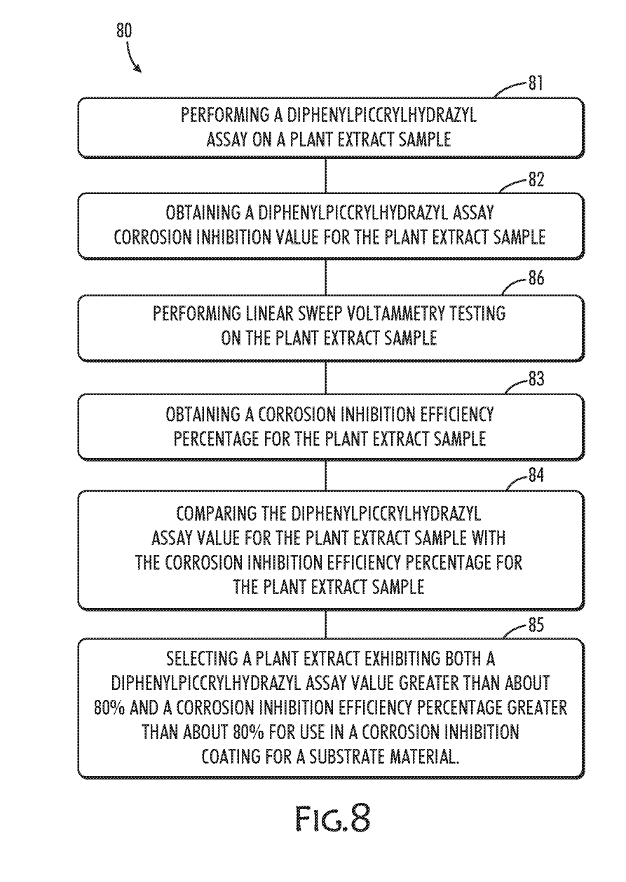

According to a further aspect of the present disclosure, FIG. 8 outlines a predictive method 80 for selecting a plant extract having a requisite level of corrosion inhibition for aluminum and aluminum alloys comprising performing a diphenylpiccrylhydrazyl (DPPH) radical scavenging assay on a plant extract sample 81, obtaining a diphenylpiccrylhydrazyl (DPPH) radical scavenging assay corrosion inhibition value for the plant extract sample 82, performing a linear sweep voltammetry testing on the plant extract sample; 86, obtaining a corrosion inhibition efficiency percentage for each of the plurality of plant extract samples 83, comparing the diphenylpiccrylhydrazyl (DPPH) radical scavenging assay value for the plant extract sample with the corrosion inhibition efficiency percentage for the plant extract sample 84, and selecting a plant extract exhibiting a diphenylpiccrylhydrazyl (DPPH) radical scavenging assay value greater than about 80% and a corrosion inhibition efficiency percentage greater than about 80% for use in a corrosion inhibition coating 85. The aspects shown in FIG. 7 are able to be incorporated into the methods shown in FIG. 8.

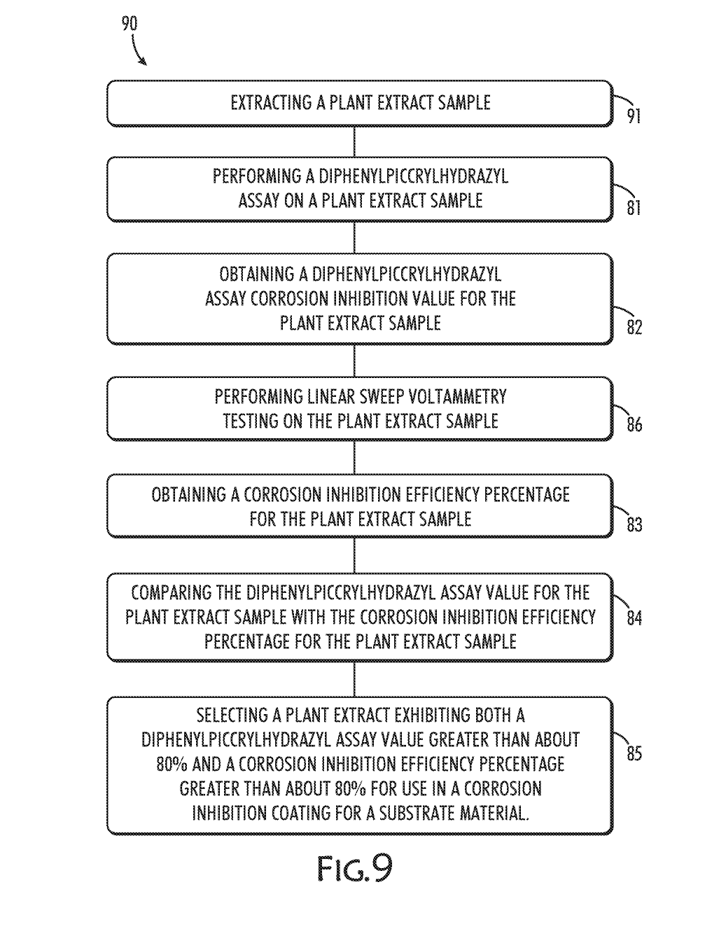

According to a another aspect of the present disclosure, FIG. 9 outlines a predictive method 90 for selecting a plant extract having a requisite level of corrosion inhibition for aluminum and aluminum alloys comprising extracting a plurality of plant extract samples 91, performing a diphenylpiccrylhydrazyl (DPPH) radical scavenging assay on a plant extract sample 81, obtaining a diphenylpiccrylhydrazyl (DPPH) radical scavenging assay corrosion inhibition value for the plant extract sample 82; performing a linear sweep voltammetry testing on the plant extract sample 86, obtaining a corrosion inhibition efficiency percentage for the plant extract samples 83, comparing the diphenylpiccrylhydrazyl (DPPH) radical scavenging assay value for the plant extract sample with the corrosion inhibition efficiency percentage for the plant extract sample 84, and selecting a plant extract exhibiting both a diphenylpiccrylhydrazyl (DPPH) radical scavenging assay value greater than about 80% and a corrosion inhibition efficiency percentage greater than about 80% for use in a corrosion inhibition coating 85. The aspects shown in FIGS. 97-8 are able to be incorporated into the methods shown in FIG. 9.

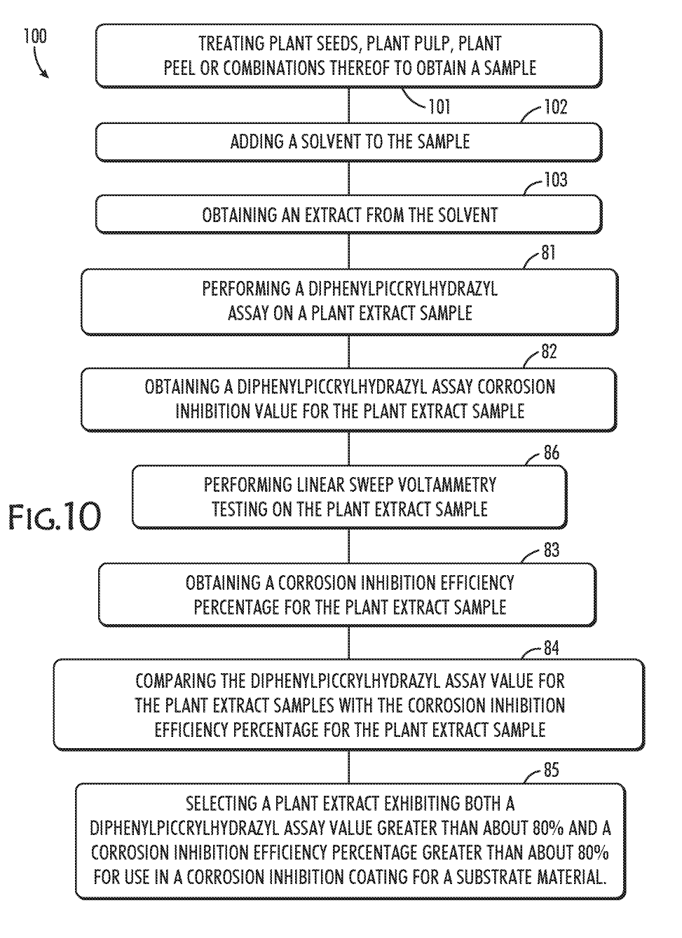

According to yet another aspect of the present disclosure, FIG. 10 outlines a method 100 for predictively selecting a plant extract having a requisite level of corrosion inhibition for aluminum and aluminum alloys comprising: treating a sample of plant seeds, plant pulp, plant peel or combinations thereof to obtain a sample 101, adding a solvent to the sample 102, obtaining an extract from the solvent 103, performing a diphenylpiccrylhydrazyl (DPPH) assay on a plant extract sample 81, obtaining a diphenylpiccrylhydrazyl (DPPH) assay corrosion inhibition value for the plant extract samples 82, performing a linear sweep voltammetry testing on the plurality of plant extract samples 86; obtaining a corrosion inhibition efficiency percentage for the plant extract samples 83, comparing the diphenylpiccrylhydrazyl (DPPH) assay value for the plant extract sample with the corrosion inhibition efficiency percentage for the plant extract sample 84, and selecting a plant extract exhibiting both a diphenylpiccrylhydrazyl (DPPH) assay value greater than about 80% and a corrosion inhibition efficiency percentage greater than about 80% for use in a corrosion inhibition coating 85. The aspects shown in FIG. 7-9 are able to be incorporated into the methods shown in FIG. 10.

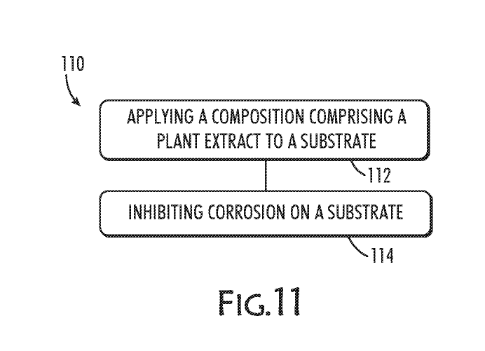

FIG. 11 is a flowchart showing an aspect of the present disclosure whereby a method for inhibiting corrosion 110 is presented comprising applying a composition comprising a plant extract to a substrate 112 and inhibiting corrosion of the substrate 114.

Variations and alternatives of the present disclosure relate to the manufacture and coating of various aluminum, aluminum alloy, copper and copper alloy substrates including, without limitation various components and parts such as, for example, component and parts of any dimension, including the manufacture and use of components and parts used in the fabrication of larger parts and structures. Such components and parts include, but are not limited to, components and parts designed to be positioned on the exterior or interior of stationary objects including, without limitation, bridge trusses, support columns, general construction objects, buildings, etc. Further components and parts include, without limitation, components and parts used in the manufacture of non-stationary objects including, without limitation, all vehicle types including, without limitation, atmospheric and aerospace vehicles and other objects, and structures designed for use in space or other upper-atmosphere environments such as, for example, manned or unmanned vehicles and objects. Contemplated objects include, but are not limited to vehicles such as, for example, aircraft, spacecraft, satellites, rockets, missiles, etc. and therefore include manned and unmanned aircraft, manned and unmanned spacecraft, manned and unmanned terrestrial vehicles, manned and unmanned non-terrestrial vehicles, and even manned and unmanned surface and manned and unmanned sub-surface water-borne vehicles and objects.

When introducing elements of the present disclosure or exemplary aspects thereof, the articles “a,” “an,” “the” and “said” are intended to mean that there are one or more of the elements. The terms “comprising,” “including” and “having” are intended to be inclusive and mean that there may be additional elements other than the listed elements. Although this disclosure has been described with respect to specific aspects, the details of these aspects are not to be construed as limitations. While the preferred variations and alternatives of the present disclosure have been illustrated and described, it will be appreciated that various changes and substitutions can be made therein without departing from the spirit and scope of the disclosure.

What is claimed is:

1. A method for inhibiting corrosion of a substrate comprising:
applying a composition to a substrate, said composition comprising an extract derived from a plant genus comprising: Annona, Inga, Mangifera; Taraxacum; Bidens; Plantango; Chamomilla; Solidago; and combinations thereof; and
inhibiting corrosion of the substrate, said substrate comprising a substrate surface.

2. The method of claim 1, wherein, in the step of applying a composition to a substrate, the composition comprising an extract derived from a plant species comprising: Annona crassiflora; Inga (sp.); Mangifera indica; Annona squamosa; Taraxacum officinale; Bidens pilosa; Plantango major; Chamomilla recutita; Solidago chilensis; and combinations thereof.

3. The method of claim 1, wherein in the step of applying a composition to a substrate the composition comprising an extract derived from a plant species comprising: Annona crassiflora; Annona squamosa; Mangifera indica; Bidens pilosa; and combinations thereof.

4. The method of claim 1, wherein in the step of applying a composition to a substrate the composition comprising an extract derived from a plant species comprising: Annona crassiflora; Annona squamosa; Mangifera indica; Bidens pilosa; and combinations thereof, and said extract is present in said composition at a concentration ranging from about 5% to about 20%.

5. The method of claim 1, wherein in the step of applying a composition to a substrate, the substrate comprising aluminum, aluminum alloy, copper, copper alloy, and combinations thereof.

6. The method of claim 1, wherein, in the step of applying a composition to a substrate, said substrate comprising aluminum alloy 2024 T3 or aluminum alloy 7075.

7. A composition for inhibiting corrosion on a substrate, said composition comprising:
an extract derived from a plant genus comprising: Annona, Inga, Mangifera; Taraxacum; Bidens; Plantango; Chamomilla; Solidago; and combinations thereof.

8. The composition of claim 7, wherein the composition comprises an extract derived from a plant species comprising: Annona crassiflora; Inga (sp.); Mangifera indica; Annona squamosa; Taraxacum officinale; Bidens pilosa; Plantango major; Chamomilla recutita; Solidago chilensis; and combinations thereof.

9. The composition of claim 7, wherein the composition comprises an extract derived from a plant species comprising: Annona crassiflora; Annona squamosa; Mangifera indica; Bidens pilosa; and combinations thereof.

10. The composition of claim 7, wherein the composition comprises an extract derived from a plant species comprising: Annona crassiflora; Annona squamosa; Mangifera indica; Bidens pilosa; and combinations thereof, and said extract is present in said composition at a concentration of about ranging from about 5% to about 20%.

11. The composition of claim 7, wherein the extract derived from a plant genus is extracted from plant seeds, plant pulp, plant peel, plant leaves, and combinations thereof.

12. The composition of claim 7, wherein the composition further comprises a primer.

13. The composition of claim 12, wherein the primer comprises a polyurethane-containing compound.

14. The composition of claim 12, wherein the composition is an additive in a coating formulation.

15. A coating for inhibiting corrosion, said coating comprising:
an extract derived from a plant genus comprising: Annona, Inga, Mangifera; Taraxacum; Bidens; Plantango; Chamomilla; Solidago; and combinations thereof.

16. The coating of claim 15, wherein the coating comprises an extract derived from a plant species comprising: Annona crassiflora; Inga (sp.); Mangifera indica; Annona squamosa; Bidens pilosa; and combinations thereof.

17. A substrate comprising a compound for inhibiting corrosion, said compound comprising:
an extract derived from a plant genus comprising: Annona, Inga, Mangifera; Taraxacum; Bidens; Plantango; Chamomilla; Solidago; and combinations thereof.

18. The substrate of claim 17, wherein the compound comprises an extract derived from a plant species comprising: Annona crassiflora; Inga (sp.); Mangifera indica; Annona squamosa; Bidens pilosa; and combinations thereof.

19. The substrate of claim 17, wherein the substrate comprises aluminum, aluminum alloy, copper, copper alloy, and combinations thereof.

20. The method of claim 1, wherein the substrate comprises aluminum alloy 2024 T3, aluminum alloy 7075, and combinations thereof.
